(19) United States
(12) Patent Application Publication
(10) Pub. No.: US 2015/0071034 A1
(43) Pub. Date: Mar. 12, 2015

(54) METHOD FOR INCREASING BROADSIDE SENSITIVITY IN SEISMIC SENSING SYSTEM

(71) Applicants: Peter Berkeley Wills, Calgary (CA); Michael Scott Costello, Katy, TX (US); Jorge Louis Lopez, Bellaire, TX (US); Kurang Jvalant Mehta, Sugar Land, TX (US)

(72) Inventors: Peter Berkeley Wills, Calgary (CA); Michael Scott Costello, Katy, TX (US); Jorge Louis Lopez, Bellaire, TX (US); Kurang Jvalant Mehta, Sugar Land, TX (US)

(21) Appl. No.: 14/235,643

(22) PCT Filed: Jul. 26, 2012
(86) PCT No.: PCT/US2012/048239

§ 371 Date: Mar. 20, 2014

Related U.S. Application Data
(60) Provisional application No. 61/513,217, filed on Jul. 29, 2011.

(51) Int. Cl. G01V 1/28; G01V 1/42

(52) U.S. Cl. CPC G01V 1/28; G01V 1/42; G01V 1/284; G01V 2210/51
USPC 367/25; 367/38

(57) ABSTRACT

A method for collecting information about a subsurface region, comprises a) providing a set of data comprising a plurality of scattered signals, where each scattered signal is a portion of an acoustic seismic signal that has been scattered by and at least one scatterer and received at a receiver, b) using spatial deconvolution to process the scattered signals so as generate a coherent arrival, and c) using the coherent arrival to output human readable information about the subsurface region. The receiver may be a geophone or a fiber optic distributed acoustic sensor and may be in a borehole or at the surface. The acoustic seismic signal may originate at the surface or below the surface and may be an active or passive source.

### TECHNICAL FIELD OF THE INVENTION

The present disclosure relates generally to methods for increasing the sensitivity of a system of seismic sensors to acoustic signals that are not aligned with the sensing direction of the sensors.

### BACKGROUND OF THE INVENTION

In a typical seismic sensing system, one or more sensors designed to collect acoustic signals are deployed in a desired location and coupled to a data collection device by a cable. For example, a plurality of geophones may be spaced apart along a data transmission cable, which is in turn connected to a computer. In oilfield applications, such cables may be distributed in one or more boreholes, in or on the surface of the earth, and/or in or on a seafloor. The sensors may be geophones, hydrophones, accelerometers, or optical acoustic sensors. Such sensors are commercially available in a variety of configurations. Suitable systems also include cable-less systems, with sensors that transmit their data wirelessly.

Less-expensive sensors are typically most sensitive to incoming acoustic signals moving along a single axis. To obtain 3-dimensional sensitivity, conventional geophones are typically combined in groups of three orthogonal orientations, sometimes referred to as “three component” or “3C” sensors. Such three-component sensors are more expensive and more complex to utilize than single-component sensors.

There are many instances in which it is either not possible, not economical, or not practical to use three-component sensors. For example, in a vertical borehole, an array of permanently installed vertical component sensors may be preferred due to cost or ease of deployment, in which case there will be no sensitivity to broadside waves, which in turn limits the illuminated area afforded by the array. Such sensors will also limit the effectiveness of cross-well seismic surveys where sources are located in a nearby well that illuminates the array in a broadside manner. Likewise, if a vertical component geophone array is installed on surface and there is a need to detect waves travelling along the surface or shear waves arriving from reflections below, the array will be insufficient. Similarly, in applications in which fiber optic cables are installed on the earth's surface as distributed acoustic sensors, the sensors tend to be insensitive to broadside waves arriving from reflections in the deeper subsurface. Some commercial fiber optic systems use fiber optic point sensors that are connected through a fiber optic cable. Such systems may include multi-component sensors, but are more likely to be outfitted with single vertical component sensors.

It is therefore desirable to provide a method for using a single-component, or one-dimensional, system in which information about lateral, or “cross-axial” or “broadside,” signals can be obtained despite limitations of the hardware.

### SUMMARY OF THE INVENTION

The present disclosure provides a method for using a single-component, or one-dimensional, system in which information about lateral, or “cross-axial” or “broadside,” signals can be obtained despite limitations of the hardware.

According to some preferred embodiments, the present invention includes a method for collecting information about a subsurface region, comprising the steps of a) providing a set of data comprising a plurality of scattered signals, where each scattered signal is a portion of an acoustic seismic signal that has been scattered by at least one scatterer and received at a receiver, b) using spatial deconvolution to process the scattered signals so as to generate a coherent arrival, and c) using the coherent arrival to output human readable information about the subsurface region.

The scatterer may be within 10 meters of the receiver and the subsurface region may be at least 25, more preferably at least 50, and sometimes at least 100 meters from the receiver.

The spatial deconvolution technique is preferably carried out using at least one method selected from the group consisting of Stolt migration, Gazdag, and Finite-difference migration Kirchhoff migration, F-K migration Reverse Time Migration (RTM), Gaussian Beam Migration, and Wave-equation migration, and diffractor imaging.

The receivers may be single component receivers, such as geophones, hydrophones, or fiber optic distributed acoustic sensors, or combinations thereof. The receivers may be at the surface, in a borehole, or in a horizontal portion of a borehole.

The acoustic seismic signal may originate at an active source, at a passive source, and/or at the surface, below the surface, and/or in a borehole. The transmission of the signal from the source to the scatterer(s) may include reflections, refractions, diffraction, or direct arrivals. It may include shear waves.

As used herein, the term “broadside” will be understood to refer to an acoustic signal in which the direction of motion of the particles perturbed by such signal is normal to, or has a component normal to, the direction of sensitivity of the sensor in question.

As used herein, the term “scatterer” refers to any acoustic discontinuity in a relatively homogeneous subsurface environment. Examples of such acoustic discontinuity include but are not limited to boulders, cavities, faults, natural or induced fractures, fluid contacts and steam chests. Likewise, topographical features, such as hills, trenches, and bodies of water can be scatterers. One skilled in the art will recognize that there is a size continuum between scatterers and reflectors. As used herein, “scatterer” is intended to refer to any object that lies within 1 wavelength of the receiver, scatters at least a portion of an incoming signal toward the receiver, and is not the object of interest. It is preferred but not necessary that scatterers have a size less than one-half, preferably less than one-third, and still more preferably less than one-tenth, of the seismic wavelength. Likewise, preferred environments include scatterers that are densely distributed and close to the receivers.

As used herein, a scatterer's size refers to its greatest dimension.

### BRIEF DESCRIPTION OF THE DRAWINGS

For a more complete understanding of the preferred embodiments, reference is made to the accompanying drawings, wherein:

FIG. 1 is a schematic illustration of an application of the concepts disclosed herein;

FIG. 2 is a schematic plan view of a second application in which the present concepts may be applied;

FIG. 3 is a schematic illustration of an alternative embodiment; and

FIG. 4 is a combined schematic illustration of several alternative embodiments of the invention.

### DETAILED DESCRIPTION OF ILLUSTRATIVE EMBODIMENTS

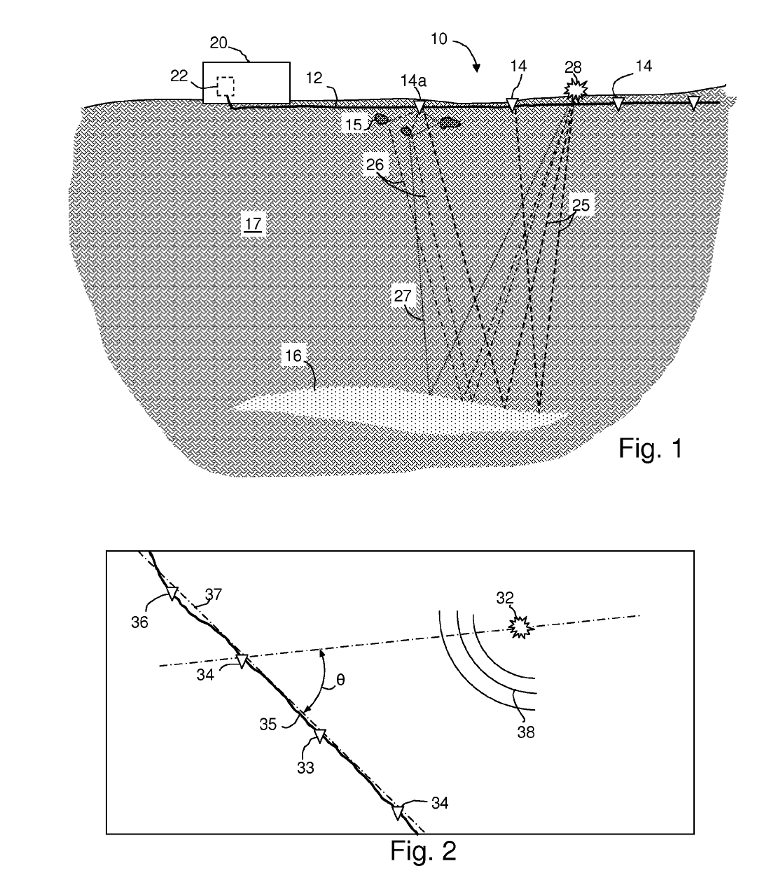

Referring initially to FIG. 1, an environment 10 in which the present concepts may be applied includes a subsurface formation in which a region of interest, reflector 16, is present in the earth 17. A sensor cable 12, which includes a plurality of sensors 14, is acoustically coupled to the earth. One end of cable 12 is connected to signal transmitting and receiving means 22, which may be housed in a sensor box 20. An acoustic source 28 is included on or near the surface of the earth, in the vicinity of cable 12. The earth contains a plurality of scatterers 15.

Sensors 14 may be geophones or distributed acoustic sensors, both of which are known in the art. The present invention has particular applicability when sensors 14 are single component sensors. If sensors 14 are distributed acoustic sensors, sensor box 20 may be a lightbox, signal transmitting and receiving means 22 may be a microprocessor-controlled laser or other light source, and cable 12 may be a fiber optic cable. Sensors 14 may be acoustically coupled to the earth by any suitable means, including burying cable 12 and sensors 14 in a shallow trench. Scatterers 15 may be naturally occurring or man-made.

Referring briefly to FIG. 2, a second environment is shown in plan view. In FIG. 2, an acoustic source 32 is spaced apart from a cable 35 that is equipped with a plurality of single component sensors, which can be characterized as near sensors 33, intermediate sensors 34, and far sensors 36. Source 32 and sensors 33, 34, 36 are all on or near the surface of the earth. The path of cable 35 approximates a line 37.

In a typical surface seismic application, sensors 33, 34, 36 will be oriented so that they are most sensitive to signals arriving from below them, i.e. signals travelling upward from the earth. With this orientation, sensors 33, 34, 36 will be relatively insensitive to signals that travel parallel to line 37. In other arrangements, sensors 33, 34, 36 may be configured to be sensitive to signals that travel parallel to line 37. In either instance, sensors 33, 34, 36 will be relatively insensitive to signals travelling along the surface of the earth from offset points such as 32.

Thus, an acoustic signal 38 emitted by surface source 32 will travel toward cable 35. Its direct arrival will reach sensor 33, which is closest to it, first and will arrive nearly perpendicular to line 37. Signal 38 will reach intermediate sensors 34 later and impact them at an angle θ that is less than 90 degrees. Signal 38 will reach far sensors 36 last. While signal 38 will impact far sensors 36 at a much smaller angle, it will have travelled a greater distance and will be correspondingly attenuated.

If sensors 33, 34, 36 are oriented so that they are most sensitive to signals arriving from below them, they may be partially sensitive to the direct arrivals (surface waves) of signal 38, whose path is normal to their direction of sensitivity. This is because the surface waves are typically elliptically polarized. However, if sensors 33, 34, 36 are oriented to be sensitive to signals travelling along the axis of cable 35, as would be the case for fiber optic distributed acoustic sensors, they would be completely insensitive to direct arrivals propagating along the surface in direction perpendicular to the cable. For this configuration, the distance required in order to achieve a sufficient signal component in the axial direction would result in a greatly attenuated signal.

Referring again to FIG. 1, the same principles may reduce the effectiveness of sensors that are nearest to the acoustic source. FIG. 1 illustrates three types of signal that may arrive at sensors 14, namely primary arrivals 25, which are reflected by region of interest 16 before arriving at a given sensor 14a, singly scattered arrivals 26, which are reflected by reflector 16 and scattered by a scatterer 15 before arriving at sensor 14a, and multiply scattered arrivals 27, which are reflected by reflector 16 and scattered by multiple scatterers 15 before arriving at sensor 14a. If sensors 14 are not oriented so as to be sensitive to signals arriving from below, primary arrivals 25 may not be effectively detected. Even though primary arrivals 25 are not effectively detected by the nearest sensors 14, signals arriving at the sensors 14 closest to source 28 may be the strongest and therefore most desirable for their high signal to noise ratio. Hence, it would be advantageous to increase the sensitivity of the sensors 14 to such “broadside” signals.

According to one embodiment of the present invention, instead of or in addition to primary arrivals 25, singly scattered arrivals 26 and/or multiply scattered arrivals 27, are processed to give information about the region of interest 16. By using signals 26 and/or 27, the present invention harnesses the wave energy scattered by heterogeneities near the sensors. This scattered energy, although incoherent, is recorded by each sensor because it includes a component in the direction of sensitivity of the sensors.

According to preferred embodiments, the signals received at a given set of receivers 14 during a predetermined time window are processed using spatial deconvolution. Such data-processing algorithms are known in the art of seismic imaging and include but are not limited to diffraction imaging including zero-offset diffraction imaging, Kirchhoff migration, Stolt migration, also called FK migration, Reverse Time Migration (RTM), Gaussian Beam Migration, Gazdag, and Finite-difference migration and Wave-equation migration. For purposes of the present invention, either time or depth migration can be used. In preferred embodiments, data from at least 10 sensors are migrated.

The result of the deconvolution will be a dataset that is equivalent to the original (raw) data, but in which the receivers have enhanced broadside sensitivity. The new dataset can, in turn, be processed to generate an image or other human-readable output.

While the preferred signal processing will result in the use of signals arriving from scatterers within 1-5 meters of each receiver, the position of scatterers is not critical. In general, the closer and more densely distributed scatterers 15 are, the better. If sensors 14 are in a vertical or horizontal borehole, fewer scatterers may be present in the vicinity of the sensors, except in cases where natural or induced fractures are present.

For optimal results, scatterers 15 preferably have an average dimension that is less than approximately one-third and more preferably less than approximately one-tenth of a wavelength. As wavelengths for surface seismic signals are typically 30 to 40 m at the surface, scatterers 15 preferably have an average dimension of at most 3 to 4 m. In instances where the signal will be transmitted to receivers in a borehole, the signal wavelength will be longer, and optimal scatterers could be correspondingly larger. Nonetheless, one skilled in the art will recognize that while the preferred scatterer size range is from about one-twentieth to one-fifth of the signal wavelength, the inventive concepts can be successfully applied using scatterers having sizes in the range of from one-fiftieth of a wavelength to one-half of the signal wavelength.

Seismic sources 14 may be active or passive sources, including microseisms, continuous sources, well drilling or completions operations, or the like. For example, by enabling single-component or single-direction sensors to detect signals that they would normally not detect, the present invention makes it possible to locate a microseismic event using single-component sensors deployed in a well. Without the concepts disclosed herein, such a sensor array would not be optimally suited to detection of microseisms whose particle motion, for P and S waves, has a large component orthogonal to the fiber. In fact, a single-component sensor would not typically be optimal for microseism location, regardless of its orientation, for either P or S waves. If scatterers are present, however, a single vertical component could record the full microseismic P wavefield. For example, with a vertical well, the P wave propagating horizontally to the well from a microearthquake could strike a scatterer near the well, creating a secondary wave field having components that are approximately aligned with the fiber, allowing it to be detected by the fiber. Similarly, an S wave travelling with the same geometry would normally strike the cable with polarization either along the fiber or orthogonal to it. In both cases, secondary waves may be produced, again having components that travel approximately along the fiber, again allowing detection of the wave disturbance.

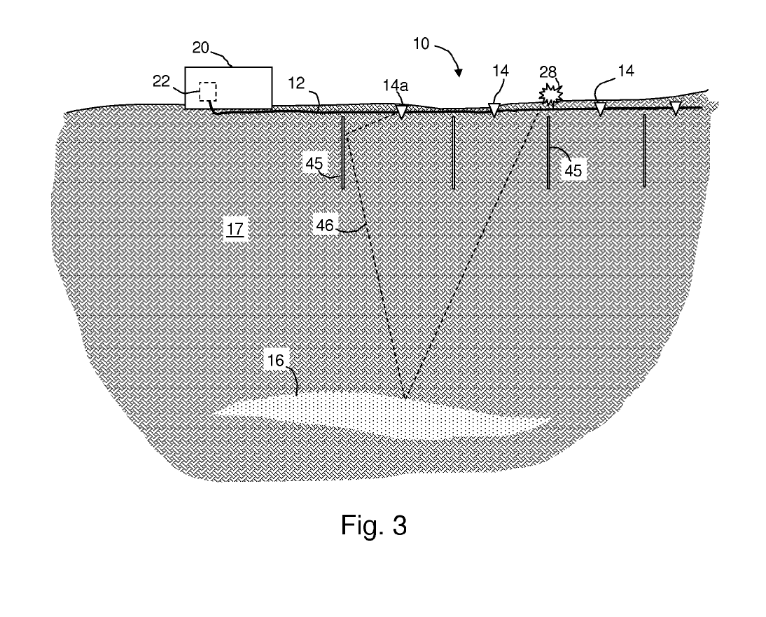

Scatterers 15 may be but are not necessarily naturally-occurring. Referring briefly to FIG. 3, in environments in which naturally occurring scatterers are not present, or not significantly present, artificial scatterers such as baffles 45 may be used to provide scattered signals 46. Alternatively, the cable could be installed in a trench in which scatterers have been co-deployed. Similarly, the requisite scattering may be artificially realized in the case of fiber optic cables used in acoustic sensing applications by building complexities into the cable construction or cable installation. Thus, by way of example only, the acoustic sensing cable could include fins, teeth, or arms affixed to, constructed within, or extending from the cable.

The concepts disclosed herein can be applied in a variety of ways. The data collection can be performed in real time, or after the fact, and/or in a time-lapse mode. Likewise, the scattered seismic signals that are collected at receivers 14 can include reflection, refraction, diffraction and other arrivals.

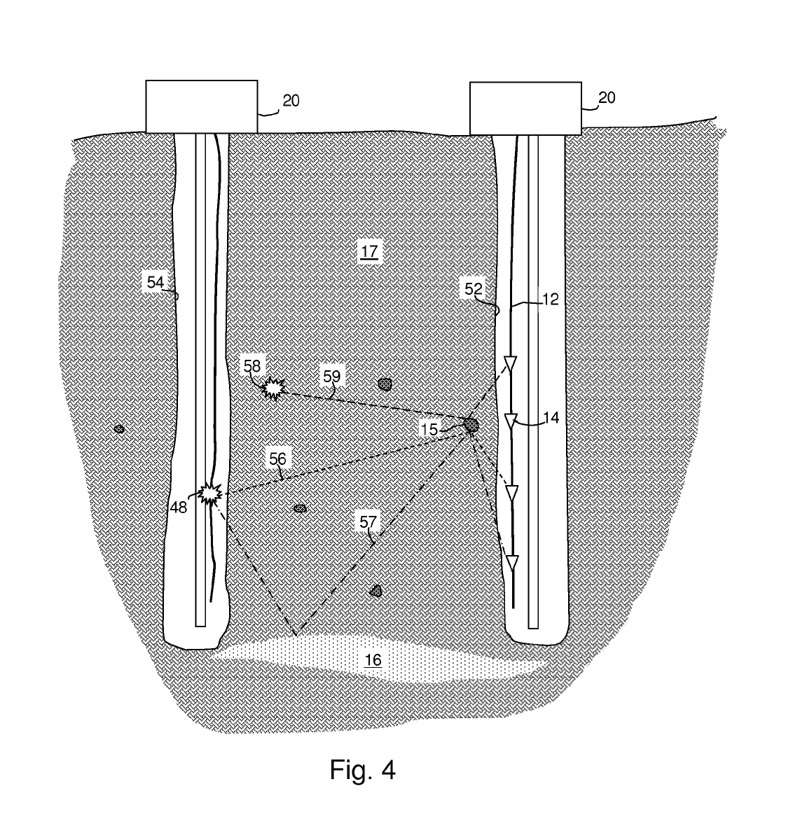

By way of illustration only, reference is now made to FIG. 4, which is a schematic illustration of several alternative embodiments of the invention. As shown, an array of receivers 14 may be deployed in a well 52. An active source 48 in a second well can be used to transmit a signal into the subsurface 17. In one embodiment, the present concepts can be used in cross-well tomography. Specifically, portions of a signal travelling toward the array of receivers are scattered by scatterers 15 such that some of the scattered signals are received at receivers 14, as shown at 56. In another embodiment, the present concepts are used in cross-well imaging. Thus, portions of a signal that has been reflected by reflector 16 travel toward the array of receivers and are scattered by scatterers 15 such that some of the scattered signals are received at receivers 14, as shown at 57.

In still another embodiment, the present concepts are used in microseismic monitoring. Thus, portions of a signal originating at a point 58 in the formation are scattered by scatterers 15 such that some of the scattered signals are received at receivers 14, as shown at 59. Seismic sources in the formation may be fractures or other subsurface seismic events and may be naturally occurring or induced.

In each case, the presence of scatterers near receivers 14 increases the signal that is can be detected at each receiver 14. The received signal can be processed so as generate a coherent arrival, that contains information about the formation (in the case of cross-well tomography), the reflector (in the case of cross-well imaging), or the microseismic event (in the case of microseismic monitoring).

The present invention generates usable information from a signal that cannot itself be readily detected by using portions of that signal that have been scattered in the vicinity of a receiver and as a result have a component in the direction of sensitivity of that receiver. In other words, the scatterers become secondary sources. In terms of processing, each scatterer may be viewed as a virtual receiver once the scattered energy measured on the array is collapsed back to the location of the scatterer.

The concepts disclosed herein are not limited to surface seismic, cross-well seismic, or microseismic and can be applied to any combination of sensors and receivers. Because the present concepts address some of the shortcomings of single component sensors, they are particularly advantageous when used with fiber optic distributed acoustic sensors.

1. A method for collecting information about a subsurface region, comprising the steps of:
a) providing a set of data comprising a plurality of scattered signals, where each scattered signal is a portion of an acoustic seismic signal that has been reflected by the subsurface region and scattered by at least one scatterer and received at a receiver;
b) using spatial deconvolution to process the scattered signals so as generate a coherent arrival; and
c) using the coherent arrival to output human readable information about the subsurface region.

2. The method according to claim 1 wherein at least one scatterer is within 10 meters of the receiver.

3. The method according to claim 1 wherein the acoustic seismic signal originates at a source and wherein the path of the signal between the source and the scatterer includes at least one of reflection, refraction, diffraction, and direct arrival.

4. The method according to claim 1 wherein the subsurface region is at least 100 meters from the receiver.

5. The method according to claim 1 wherein the spatial deconvolution technique is carried out using at least one method selected from the group consisting of Stolt migration, Gazdag, and Finite-difference migration Kirchhoff migration, F-K migration Reverse Time Migration (RTM), Gaussian Beam Migration, and Wave-equation migration, and diffractor imaging.

6. The method according to claim 1 wherein at least one receiver is a single component receiver, a geophone, or a fiber optic distributed acoustic sensor.

7. The method according to claim 1 wherein the data are received at a plurality of receivers at the surface.

8. The method according to claim 1 wherein the data are received at a plurality of receivers in a borehole.

9. The method according to claim 8 wherein the receivers are in a horizontal portion of a borehole.

10. The method according to claim 1 wherein the acoustic seismic signal originates at a source at the surface.

11. The method according to claim 1 wherein the acoustic seismic signal originates below the surface.

12. The method according to claim 11 wherein the acoustic seismic signal originates in a borehole.

13. The method according to claim 1 wherein the acoustic seismic signal includes shear waves.

14. The method according to claim 1 wherein the scattered signal includes shear waves.
